(19) United States
(12) Patent Application Publication
(10) Pub. No.: US 2010/0087762 A1
(43) Pub. Date: Apr. 8, 2010

(54) Acupressure and Massaging Device

(76) Inventor: Lawrence Alan Herbert, Aptos, CA (US)

Correspondence Address: Lawrence A. Herbert, 1733 Wilshire Dirve, Aptos, CA, 95003, US

(21) Appl. No.: 12/246,477

(22) Filed: Oct. 6, 2008

(51) Int. Cl. A61H 7/00

(52) U.S. Cl. 601/134

(57) ABSTRACT

An acupressure and massaging device comprised of a plurality of spherical elements, contained within an enclosed flexible envelope positioned on any surface providing adequate support, and against which device the user's body is in put in contact either while at rest or while in motion.

### BACKGROUND OF THE INVENTION

The invention relates to acupressure, trigger point therapy, and massaging devices for both human and animal bodies. More specifically, it relates to novel improvements in surface-supported devices having spherical elements and sphere containment structures, components, and or carriers, that when in use by lying, pressing, squeezing, holding, and or moving there against, provide pressure and manipulation at points of contact with the user. Such pressure and manipulation at each point of contact is simulating and or producing some of the effects of manual human massage and acupressure manipulation.

Health care professionals have identified massage, acupressure, finger pressure therapy, shiatsu, and trigger point therapy as beneficial to rehabilitation when treating myofacial pain syndrome, specific injuries, soreness, aches, pain, discomfort, and other irregularities associated with muscles and soft tissue. Most people experience the rehabilitating, pain reducing, and relaxing effect of the aforementioned treatments which can provide stimulation, improved circulation, improved flexibility, pain relief, and muscle rehabilitation when employed.

The main objective of the invention is to simplify, make more functional, modifiable, and more efficient, the structure of the spherical element support, control, and containment components used for massage, acupressure, and trigger point therapy devices.

Pertinent devices as exemplified in the prior art are U.S. Pat. No. 6,393,642 to Huibert Paul Pollman, 2002; U.S. Pat. No. 6,390,997 to David M. Vitko, 2002; U.S. Pat. No. 5,779,652 to Bonnie Mencher-Aliazzo, 1998; U.S. Pat. No. 5,628,772 to Robin Russell, 1997; U.S. Pat. No. 5,316,149 to David J. Tate, 1994; U.S. Pat. No. 5,079,787 to Huibert Paul Pollman, 1992; U.S. Pat. No. 4,936,294 to Jennifer Chu, 1990; U.S. Pat. No. 4,974,582 to Gary C. Johnson, 1990; and U.S. Pat. No. 4,796,616 to Yousef Panapour, 1989.

In contrast to such prior art, the invention is a simple flexible envelope that provides containment for independent spherical elements and allows each spherical element freedom of movement in any direction, while conforming to a selected support surface. A wide variety of independent spherical elements (balls) of different sizes, hardness, flexibility, and composition may be utilized. However, if compressible, it must be able to support a user's body weight without collapsing, deflating, or compressing whereas it can no longer effectively roll in order to function properly and provide acupressure, trigger point, and massage treatment.

Panapour, deemed the closest of prior art cited, utilizes a planar inflexible carrier structure that is limited to flat rigid surfaces to function properly. The device cannot conform to some contours and treat all parts of the user's body. The spherical elements cannot be modified and the device has a rigid frame making it cumbersome and unwieldy.

Mencher-Aliazzo uses an assembly of a plurality or series of similar resilient and compressive spheres slidably mounted on and between the ends of an elongate and flexible element. Each spherical element is limited to rotation on a single axis of the elongated flexible carrier which restricts rotational motion that is not parallel to the axis. The connecting hooks are irregular shapes that can create discomfort for the user and disrupts smooth rotation of the spheres in some directions. The device also does not provide support to adjacent areas of the user being treated, whereas the proposed invention provides a wider support area. Furthermore, the variety of spherical elements available for any modifications to the patented device is limited by the requirement of a hole bored from one side, through its center, to the opposite side. The proposed invention can utilize any spherical element within the flexible envelope, and modifications to embodiments with an access port are only limited by the diameter of the access port.

Pollman, (U.S. Pat. No. 5,079,787) utilizes a flexible envelope containing a large clumped quantity of small sized deformable loose pieces, each of which is enclosed within an individual bag of low friction fabric material, as a pressure equalizing support structure. It is stated that the loose pieces create a compact yet easily deformable mass, and the result is minimal distortion of body tissue to the user, who should feel that the device contains a viscous liquid. Whereas with the invention, the flexible enclosure contains a single layer of larger size (1-10 inch diameter) spheres that are rigid or compressible and the result is significant distortion of body tissue creating multiple pressure points, and the user should feel the device contains firm round balls. A specific embodiment of the Pollman patent is similar to the invention, however the intended effect for the user is to provide a comfortable support cushion utilizing a large compact quantity of small deformable elements, not to provide acupressure and massage treatment. While the invention can also function as a support cushion and or pillow, the intended effect is to provide acupressure, trigger point therapy, and massage treatment utilizing rigid or compressible balls, each ball being capable of supporting the user's body weight with only minimal deformation.

Pollman, (U.S. Pat. No. 6,393,642) utilizes a flexible envelope container that is sealed and not modifiable by the user. The internal elements have a shape that only approaches the spherical shape, consisting of a gas-filled, flexible and thin-walled covering of gas-tight design, so the elements are deformable for distributing a load over the supporting device. Whereas, the proposed invention utilizes true sphere (ball) shaped elements within the flexible container and are only slightly deformable when under the load of the user. Although this patent is similar to the invention, the intended effect is to provide a comfortable support cushion, not to provide acupressure and massage treatment. While the invention will also function as a support cushion and or pillow, the intended effect is to provide acupressure, trigger point, and massage treatment.

Tate utilizes an enclosed device containing a plurality of 3-5 mm diameter beads and is described as a reusable packaging device, the main function being to fill empty space within a packaging container, thus securing the items inside. The invention utilizes true spheres with a minimum diameter of one inch, and the intended effect it to provide acupressure, trigger point, and massage treatment.

Other objects and features of the invention include; simplicity of design, no auxiliary power requirements, minimum weight, easily modifiable, conforms to any supporting surface, and is self-contained for ease of portability, packaging and storage.

### SUMMARY OF THE INVENTION

The invention more fully utilizes a variety of massage, trigger point therapy, and acupressure balls, by containing them in such a manner that they can independently rotate in any direction, and will conform to any surface with which it is in contact. The invention is comprised of a flexible envelope (container) encompassing a plurality of spherical elements. The main function of the flexible envelope is to contain the spherical elements and allow each one independent movement in any direction, and conform to any supporting surface selected, and interface with the user's body. The function of the spherical elements is to apply concentric points of pressure while in contact with selected parts of the user's body requiring treatment.

Operation of the invention involves placement of the device upon a selected supporting surface such as a floor, bed, sofa, table, chair, or wall and against which the area of the body selected for treatment is applied with sufficient weight, pressure, or force. Remaining static, it will affect an acupressure function. When the body area in contact with the invention is put in motion either by the user or by other methods (i.e. a person or a mechanical device applying force and or motion to the user, the invention, or both,) he or she will experience the massage effect. Because of the self contained and flexible nature of the invention, it can be used on any area of the user's body with a stimulating effect.

### DESCRIPTION OF THE DRAWINGS

Accompanying this specification are drawings showing preferred forms of the invention wherein:

FIG. 1 shows perspective view of a preferred embodiment that is a circular shaped flexible envelope with a portion thereof being shown partially peeled away to illustrate the containment of the spherical elements therein.

FIG. 2 shows a top view cross section of a preferred embodiment that is a circular shaped flexible envelope 1 with uniform sized spherical elements 2 and a drawstring re-sealable access port 3.

FIG. 3 shows a top view cross section of an embodiment that is a circular shaped flexible envelope 1 with uniform sized spherical elements 2 and a drawstring re-sealable access port 3 with a flexible retaining element 4 that contains the spherical elements and provides additional support to the flexible envelope.

FIG. 4 shows a top view cross section of an embodiment that is a rectangular shaped flexible envelope 1 with uniform sized spherical elements 2 and a drawstring re-sealable access port 3.

FIG. 5 shows a top view cross section of an embodiment that is a rectangular shaped flexible envelope 1 with uniform sized spherical elements 2 and a drawstring re-sealable access port 3 with flexible retaining elements 4 that provide additional structure and support for the flexible envelope and align the spherical elements in desired formations.

FIG. 6 shows a top view cross section of an embodiment that is an elongated tubular shaped flexible envelope 1 with uniform sized spherical elements 2 and a drawstring fiber cord 3 that functions both as a handle and re-sealable access port, and a fiber cord 4 as the opposite handle.

FIG. 7 shows a cross section view of a flexible envelope 1 with uniform sized spherical elements 2 and a drawstring re-sealable access port 3.

FIG. 8 shows a cross section view of a flexible envelope 1 with varying sized spheres 2 and a drawstring re-sealable access port 3.

FIG. 9a shows a perspective and diagrammatic view of a user lying supinely on and supported by a planar configuration underlying invention.

FIG. 9b is a perspective and diagrammatic view of a user lying supinely on and supported by a non-planar random stacked or random piled (pillow) configuration underlying invention.

FIG. 10a shows a perspective and diagrammatic view of a user seated on and supported by a planar configuration underlying invention.

FIG. 10b shows a perspective and diagrammatic view of a user sitting vertically with the back of the anatomy pressing against a non-planar random stacked or random piled (pillow) configuration of the invention B that is positioned against a vertical support such as a wall or the back of a chair W.

FIG. 11a shows a top view of the preferred embodiment composed of stitched S panels of a textile fabric forming a circular shaped flexible envelope 1 with a drawstring re-sealable access port 3.

FIG. 11b shows a bottom view of the preferred embodiment composed of stitched S panels of a textile fabric forming a circular shaped flexible envelope 1.

FIG. 11c shows a side elevated view of the preferred embodiment composed of stitched S panels of a textile fabric forming a circular shaped flexible envelope 1 with a drawstring re-sealable access port 3.

FIG. 12 shows a cross section of one embodiment of a spherical element that is hollow 7. The interior hollow cavity can contain at any pressure any compound, substance, or mixture including solids, liquids, gases, or any combination of each. The outermost layer or shell 5 can be composed of a smooth low friction material bonded to an inner layer 6 that is composed of a resilient synthetic, rubber, or foam material. It may be composed of any number of layers and of any combination of materials. The materials utilized may be heat conducting and be heated or cooled by transference methods such as conventional, convection, and or microwave ovens, electrical heating devices, solar energy, refrigeration, or any other method that can be used to increase or decrease the temperature of the spherical elements and be re-radiated and absorbed by the user during treatment.

FIG. 13 shows a top view of an embodiment of a spherical element 8 that is solid such as ethyl vinyl acetate (EVA) foam or polyurethane (PU) foam.

### DETAILED DESCRIPTION OF THE INVENTION

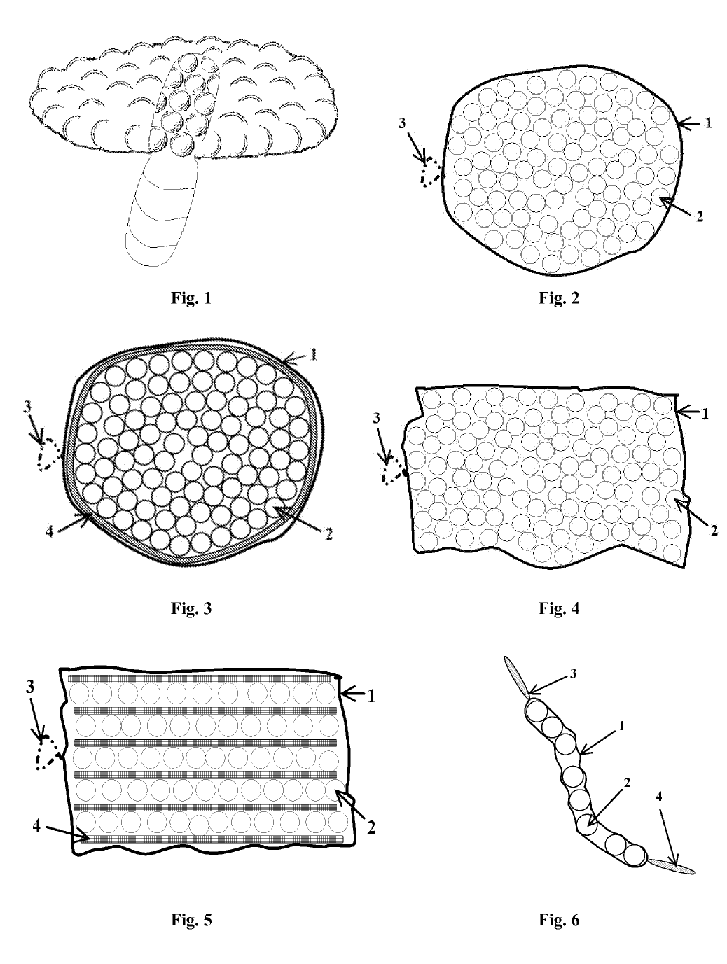

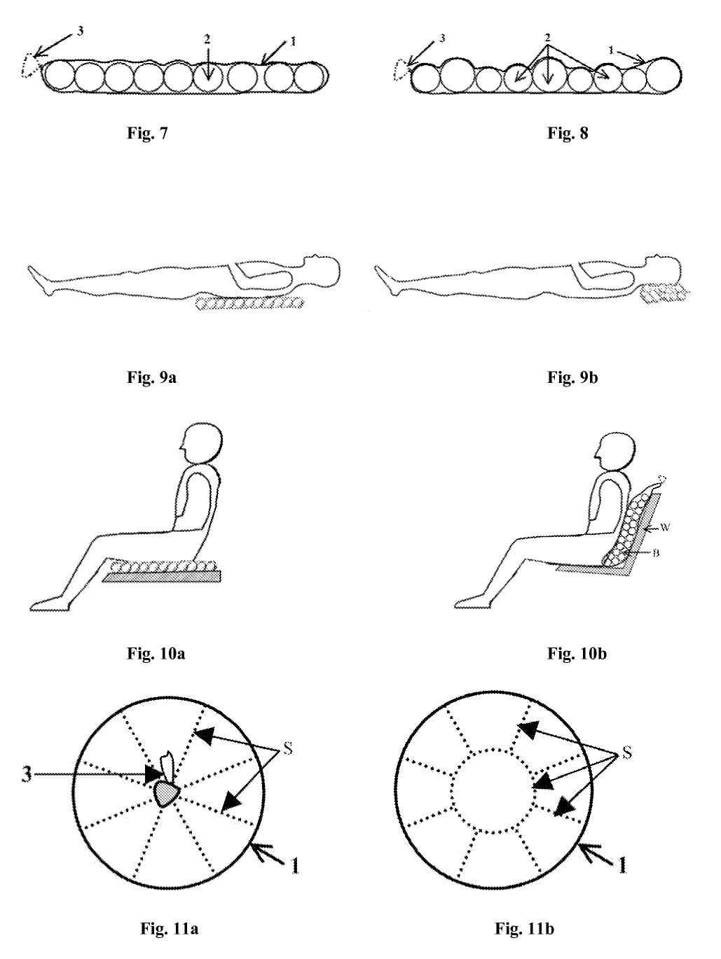

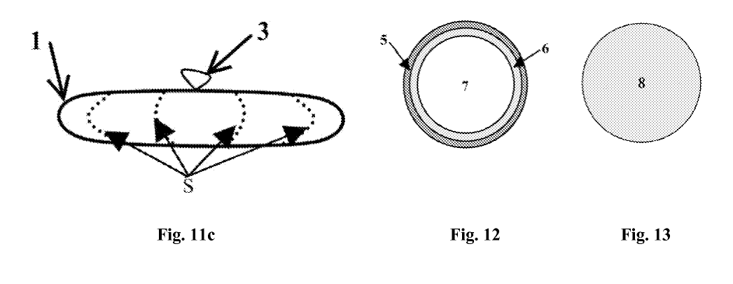

The invention and the preferred form shown in the accompanying drawings relate to an acupressure, massage, and trigger point therapy apparatus for treatment of common muscular ailments, soreness, irregularities, pain, spasms, injuries, myofacial pain syndrome, and other conditions. As illustrated in FIGS. 1-9a and 10a, the invention is comprised of a plurality of spherical elements 2 forming a layer contained within a flexible envelope 1. In such assemblage, the invention can be supported on almost any surface such as a floor, wall, table, sofa, chair, or bed.

The invention is designed to support a user's body part, weight, pressure, force, and movement. Acupressure treatment is accomplished by the user's body part resting on or exerting varying pressure against the invention, for example, while lying in a supine position as in FIGS. 9a, and 9b. Implemental massage treatment is accomplished whenever desired by initiating body part movement to engage and control the spherical elements movement in any direction. In this event, each spherical element contained within the flexible envelope is independent of one another and of the flexible envelope, and are able to freely rotate and allow the user to experience a massage effect.

The flexible envelope may be constructed of synthetic, natural, or any combination or blend of materials, and may have a re-sealable access port such as a drawstring, zipper, snaps, buttons, Velcro, or any other re-sealable apparatus or design to facilitate modifying the quantity, size, and or composition of the spherical elements by inserting and or removing selected spherical elements as determined by the user.

FIGS. 1, 2, 3, 11a, 11b, and 11c illustrate the preferred flexible envelope 1, which is a circular shape that facilitates movement in any direction, comprised of a durable and supple textile fabric stitched S panels, with a drawstring re-sealable access port 3. The flexible envelope may be any size, however, a recommended size would be 22 inches in diameter that will support a large area of the body such as the user's upper torso.

The preferred embodiment will allow the user to configure the number and the properties of spherical elements contained within the flexible envelope. For optimal effect, a single layer of spherical elements is preferred, however, more spherical elements can be inserted resulting in a random stacked or random piled (pillow) configuration. The spherical elements can be similar or dissimilar with a combination of physical properties that are elastic or rigid, solid, or hollow with an internal cavity space at any pressure of any substance, compound, or mixture, resilient or non-resilient, and uniform or varied in size. The spherical elements can vary between one inch and ten inches in diameter. To achieve the desired effect, the minimum diameter of a spherical element is one inch and will differentiate the invention from existing prior art such as beanbag chairs and other cushioning devices.

Although any spherical element (ball) can function within the flexible envelope, the preferred spherical element most desirable in size, physical properties, availability, and cost would be a resilient solid sphere 3.5 inches in diameter and composed of Ethyl Vinyl Acetate foam (EVA) or Polyurethane foam (PU) with a hardness of 25-45 Shore A.

The most economical and available spherical element is a standard tennis ball two and one-half inches in diameter. If the user determines spherical elements with different properties are required, the user would open the re-sealable access port of the flexible envelope and make the appropriate modifications by adding and or removing spherical elements and re-sealing the flexible envelope.

Multiple inventions may be used simultaneously to treat or support other desired areas of the body.

Mode of Operation

The mode of operation is comprised of the following steps:
(a) If the embodiment has a re-sealable access port the user may configure the invention if desired by inserting or removing selected spherical elements within the flexible envelope and sealing it closed;
(b) selecting any area of the body that the user would like treatment;
(c) positioning the invention over a selected supporting surface so as to embrace areas requiring treatment;
(d) applying the selected body part against the flexible envelope.
(e) either remaining stationary or initiating movement (such as oscillating) the body part supported by the flexible envelope.

In a planar configuration, the invention is spread over any flat surface such as a floor, bed, chair, or table. The user then places his or her body part against the invention, for example, supinely as in FIG. 9a or seated as in FIG. 10a.

In a non-planar configuration the invention is manipulated whereby the spherical elements within the flexible envelope will stack or pile together creating a random arrangement and non-planar irregular surface. For instance, to orient the spherical elements in a clumped formation, holding the flexible envelope and allowing all the balls to pile at the bottom and then folding, or rolling up the empty (excess) portion of the envelope onto itself, or tying off the empty portion, thus reducing the available space for the balls within the flexible envelope. The invention is placed on any surface such as a bed, chair, sofa, or cushion. The user then places his or her body part against the invention, for example, lying supinely as in FIG. 9b, or seated as in 10b.

Resting the body against the invention and applying body weight, pressure, or force directed to the spherical elements of the invention underlying the troubled spot as stated, produces an acupressure treatment for muscular stimulation, circulation, and relaxation.

If the user identifies areas where concentrated manipulation and further implemental treatment of massage is desired, this is accomplished by initiating body movement (such as oscillation) and controlling the body weight and pressure concentrated over such areas.

Thus, the invention provides a twofold function, acupressure at rest and or massage with body or device movement. Treatment may be continued as long as required or desired. While using the invention, adjacent untroubled areas are also embraced and receive treatment and exercise.

Briefly stated, the invention can be reduced to practice by exercising two steps: (1) spreading the invention on an appropriate surface capable of supporting and adapting to any area of the user's body selected for treatment; and (2) having the user come into contact with the invention, applying body weight pressure and or other force, and remaining stationary for acupressure treatment or initiating motion for massage treatment.

The invention is presented in its simplest embodiments as an acupressure and massage device. Other embodiments with extensions or handle designs can be incorporated into the flexible envelope to allow better manipulation of the device or to hang it on vertical supporting surfaces such as a door or wall. Yet another embodiment, allows for flexible retaining elements such as flexible tubing or high density synthetic foam to increase the stability and functioning of the flexible envelope, and or for alignment and formation of the spherical elements.

Other embodiments include spherical elements of a composition that can utilize heating or cooling systems to increase or decrease the temperature of the spherical elements which further enhances the therapeutic effects of its use. Other persons or mechanical systems can be utilized to provide motion, pressure, and or force to the user, the flexible envelope, the spherical elements, or any combination thereof, while the user is in contact with the invention, allowing the user an effortless massage effect.

The invention can also be described and used as a therapeutic pillow, cushion, or mattress.

The drawings, mode of operation and description of the invention are illustrative and explanatory, and various changes and modifications in structure and procedure may be resorted to without departing from the spirit of the invention and the scope of the appended claims.

### U.S. Patent Documents

| | | |
|---|---|---|
| 6,393,642 | 2002 | Pollman |
| 6,390,997 | 2002 | Vitko |
| 5,779,652 | 1998 | Mencher-Aliazzo |
| 5,628,772 | 1997 | Russell |
| 5,316,149 | 1994 | Tate |
| 5,079,787 | 1992 | Pollman |
| 4,936,294 | 1990 | Chu |
| 4,974,582 | 1990 | Johnson |
| 4,796,616 | 1989 | Panapour |

I claim:

1. An acupressure and massaging device, comprised of a single layer of a plurality of spherical elements, each of which is a true spherical shape (ball) when at rest with no force upon it, and has a diameter between one inch and ten inches, with any combination of properties including; flexible, resilient, compressible, rigid, uncompressible, solid, perforated, or hollow with an internal cavity space containing at any pressure any substance, compound, or mixture, contained within an enclosed flexible envelope of any size and shape, composed of synthetic or natural materials or any combination thereof, each spherical element being freely moveable relative to each other and to the flexible envelope.

2. An acupressure and massaging device according to claim 1, whereby the flexible envelope has a re-sealable access port such as a drawstring, zipper, snaps, buttons, Velcro, or any other re-sealable access port apparatus or design.

3. An acupressure and massaging device according to claim 1, whereby the flexible envelope is a circular, elliptical, or sphere shape, and with or without a re-closeable access port or apparatus of any design.

4. An acupressure and massaging device according to claim 1, characterized in that each spherical element contained within the flexible envelope, is compressible and of solid composition in whole or in part of Ethyl Vinyl Acetate (EVA) foam.

5. An acupressure and massaging device according to claim 1, characterized in that each spherical element contained within the flexible envelope is compressible and comprised in whole or in part of Ethyl Vinyl Acetate (EVA) foam with an internal cavity space containing at any pressure any substance, compound, or mixture.

6. An acupressure and massaging device according to claim 1, characterized in that each spherical element contained within the flexible envelope is compressible and of solid composition in whole or in part of Polyurethane (PU) foam.

7. An acupressure and massaging device according to claim 1, characterized in that each spherical element contained within the flexible envelope is compressible and comprised in whole or in part of Polyurethane (PU) foam with an internal cavity space containing at any pressure any substance, compound, or mixture.

8. An acupressure and massaging device according to claim 1, characterized in that each spherical element contained within the flexible envelope is rigid or compressible, and of solid composition in whole or in part of an elastic compound such as synthetic rubber or plastic.

9. An acupressure and massaging device according to claim 1, characterized in that each spherical element contained within the flexible envelope is rigid or compressible and comprised in whole or in part of an elastic compound such as synthetic rubber or plastic with an internal cavity space containing at any pressure any substance, compound, or mixture.

10. An acupressure and massaging device according to claim 1, characterized in that retaining elements are contained within the flexible envelope to provide additional support to the flexible envelope and or align the spherical elements into selected formations.

11. An acupressure and massaging device according to claim 1, characterized in that multiple layers of spherical elements are contained within the flexible envelope, resulting in an irregular, random stacked, or random piled configuration.
